(19) United States
(12) Patent Application Publication
(10) Pub. No.: US 2014/0287273 A1
(43) Pub. Date: Sep. 25, 2014

(54) Portable Ground Power Source for Starting Aircraft

(71) Applicants: Trung Hung Nguyen, Norton, MA (US); Scott Urschel, Chandler, AZ (US)

(72) Inventors: Trung Hung Nguyen, Norton, MA (US); Scott Urschel, Chandler, AZ (US)

(21) Appl. No.: 13/849,568

(22) Filed: Mar. 25, 2013

(51) Int. Cl. H01M 10/42; H01M 10/48; H01M 10/0525

(52) U.S. Cl. CPC H01M 10/4257; H01M 10/0525; H01M 10/488; H01M 2010/4271
USPC 429/7; 429/121; 429/90

(57) ABSTRACT

Methods and apparatus for a portable ground power source for starting aircraft. An apparatus includes a Li-ion battery pack and a NATO connector integrated into a single unit and packaged inside a light weight plastic housing.

### BACKGROUND OF THE INVENTION

The present invention relates to portable power supplies, and more specifically to a portable ground power source for starting aircraft.

Commercially available portable ground power battery packs are heavy (>30 lbs) and require the use of a power cable. The standard ground power unit (GPU) system includes a power source, a multistage electronic charger, and heavy duty cables with an aviation NATO connector.

To start an aircraft, a ground crew wheels the GPU to a location near the aircraft, removes the electrical cables and connects them to the input of the aircraft. After start-up, the cables are unplugged and the GPU unit is wheeled away for storage.

A concern for a pilot is starting the engine when the aircraft has landed in a remote location. The pilot will have to rely on the aircraft primary battery to restart the engine. If the primary battery does not have enough charge or power to start the engine, the aircraft will be stranded and will require fly-in help.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features an apparatus including a Li-ion battery pack and a NATO connector integrated into a single unit and packaged inside a light weight plastic housing.

In another aspect, the invention features a portable ground power source including a housing enclosing a ground terminal, positive terminals, a battery module, a battery management unit (BMU) and a battery health management (BHMU) unit.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1 is a block diagram of a portable ground power source of the invention.

FIG. 2 is a block diagram drawing showing detail views of the battery modules.

FIG. 3 is a block diagram.

FIG. 4 shows a two module battery.

FIG. 5a/5b shows the startstick with one battery module. FIG. 1 is a block diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

A portable ground power source for starting aircraft of the present invention includes a battery and a NATO connector integrated into a single unit and packaged inside a plastic housing. The portable ground power source for starting aircraft is referred to herein as a startstick. The light weight startstick can be carried by hand and is plugged directly into an external power input to start an aircraft with no booster cables needed. The startstick self-sticks itself to a power input of the aircraft during startup. The startstick can be easily transported and conveniently stored on the aircraft after start up the engine.

The portable ground power source of the present invention provides a light weight, portable power unit that incorporates a battery and a NATO connector into a single unit. The portable ground power source is designed to start helicopters and fixed wing aircraft in the field or in remote locations.

The portable ground power source of the present invention offers a portable power unit with unique properties by eliminating the electrical cable and combining the connector into the battery. The present invention achieves unmatched portability and significant weight savings over other ground power units.

The portable ground power source of the present invention is compact, ergonomic and can be connected to, for example, a helicopter, without the use of a power cable. A NATO aircraft connector is built-into the battery. With this design, the battery can be plugged directly onto the helicopter power input. Three LEDs indicating an operating status of the battery pack are viewable in the upper right corner of the unit. An On-Off power switch is also provided for the battery.

To start an engine, a crew can plug the portable ground power source directly into the power input and start the aircraft. A significant advantage of the portable ground power source is its light weight, compactness, portability and high power output. By eliminating the use of cables and by integrating the NATO connector into the battery, the portable ground power source of the present invention provides unmatched portability. The portable ground power source can be simply stowed away in the aircraft to provide emergency backup power if needed.

The portable ground power source includes a rechargeable Li-ion battery pack capable of providing high current output and an integrated aircraft NATO 3-pin connector packaged inside a common plastic housing. The Li-ion battery pack is controlled by an electronic battery management unit. The portable ground power source has a modular architecture. To increase current output and capacity, multiple battery modules can be stacked in parallel inside the plastic housing. This novel and ergonomic portable ground power source offers significant weight and easy-operating advantages and can be easily stored on the aircraft.

An example of such a portable ground power source includes a battery (with lithium ion cells), a NATO aircraft connector, and an internal battery management unit. The 28V battery module is a stand-alone power source that contains 24 high power Li-ion cylindrical cells connected in 3P8S configuration.

The battery module is controlled by electronic Battery Management Unit (BMU) circuit that sets charge/discharge limits and insures the overall safety of the system. The Battery Safety Protection circuitry provides firmware monitoring of the pack voltage and current levels, and can disconnect the pack from an external load or a charger to prevent battery failure by shutting off control FETs. For safe operation, the BMU continually monitors the battery voltage, current, and temperature within the pack and protects the battery against adverse safety conditions such as overcharge, over-discharge, short circuit, and high temperatures.

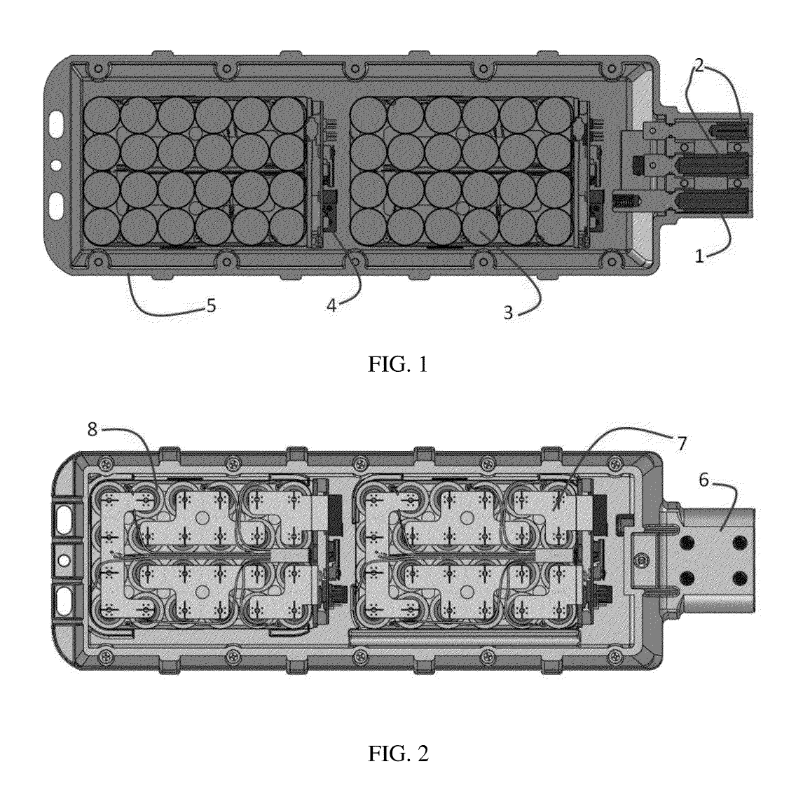

As shown in FIG. 1, an exemplary portable ground power source of the present invention includes a ground terminal 1, positive terminals 2, 28V battery module with Li-ion cells 3, battery management units (BMU)s and Battery Health Management (BHM) 4, and a light weight plastic housing 5.

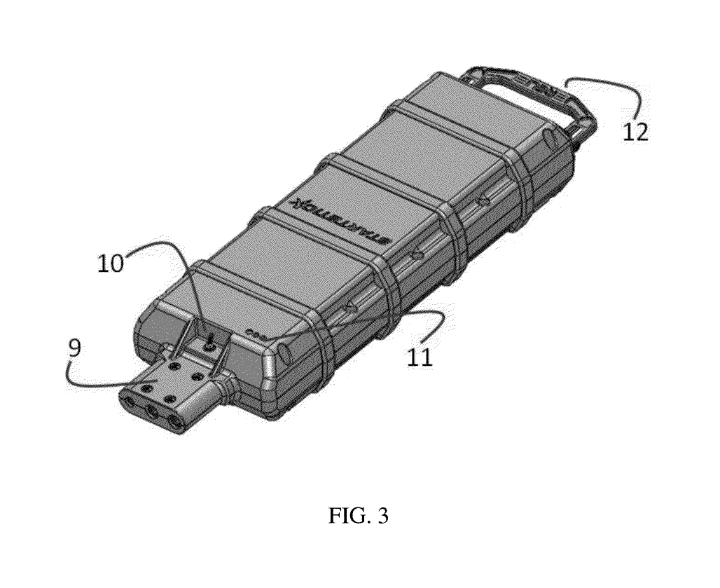

As shown in FIG. 2, the battery modules include a NATO 3-pin connector 6, a Ni tab serving as interconnect between cells 7, and a high power Li-ion cell 8.

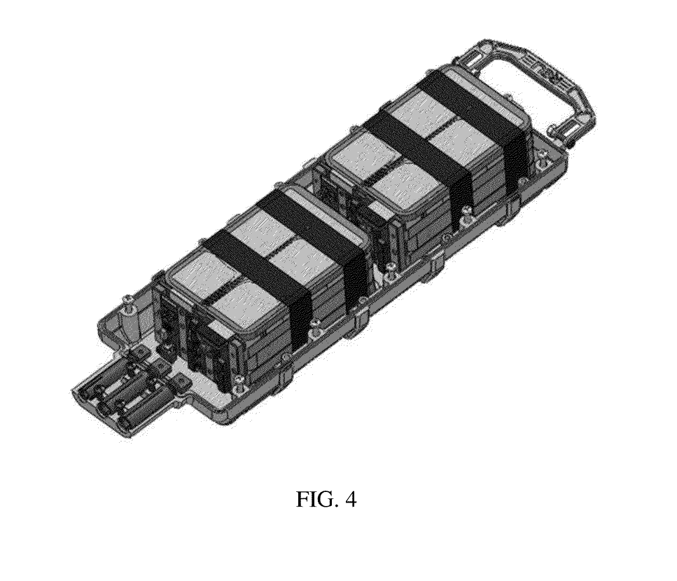

As shown in FIG. 3, the portable ground power source includes a NATO connector 9, an On/Off power switch 10, LEDs battery status indicator 11, and a carrying handle for the battery package 12.

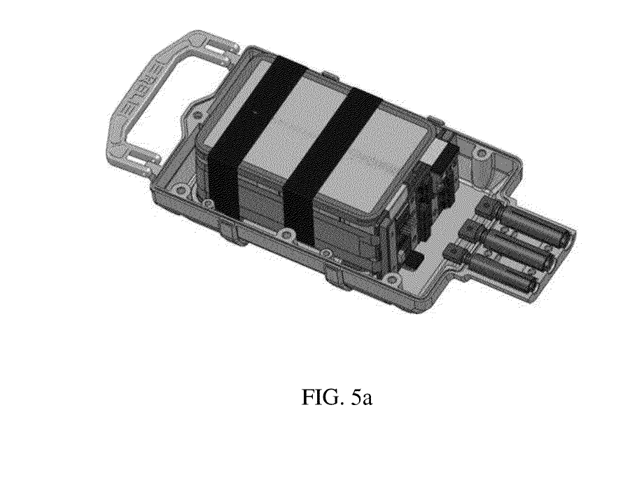

FIG. 4 shows a two module battery.

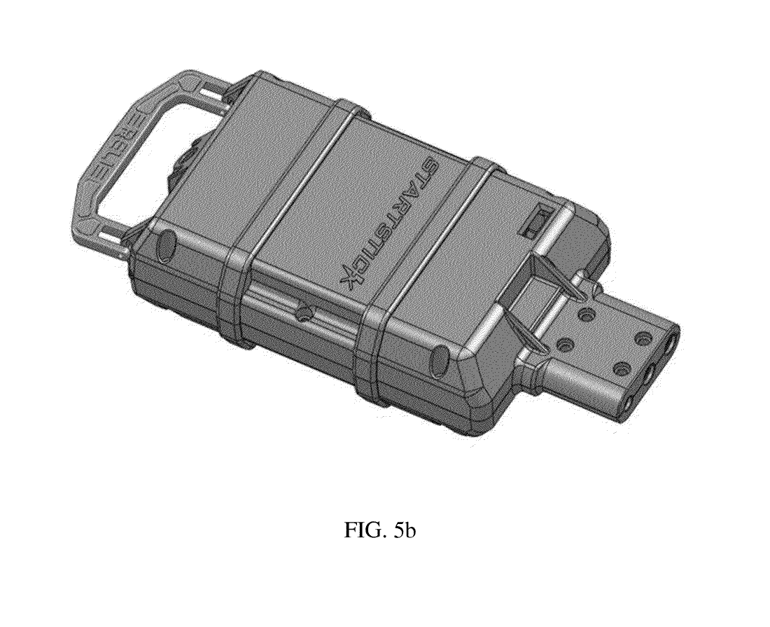

FIG. 5a/5b show the startstick with one battery module.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here. Accordingly, other implementations are within the scope of the following claims.

What is claimed is:

1. An apparatus comprising:
a Li-ion battery pack and a NATO connector integrated into a single unit and packaged inside a light weight plastic housing.

2. The apparatus of claim 1 further comprising:
multiple light emitting diodes (LEDs) positioned on an exterior of the housing, the multiple LEDs indicating an operating status of the Li-ion battery pack.

3. The apparatus of claim 1 further comprising an electronic battery management unit inside the light weight plastic housing for control of the Li-ion battery pack.

4. The apparatus of claim 3 wherein electronic battery management unit sets charge/discharge limits of the Li-ion battery pack.

5. The apparatus of claim 1 wherein the Li-ion battery pack comprises a 28V battery module including 24 high power Li-ion cylindrical cells connected in 3P8S configuration.

6. A portable ground power source comprising:
a housing enclosing a ground terminal, positive terminals, a battery module, a battery management unit (BMU) and a battery health management (BHMU) unit.

7. The portable ground power source of claim 6 wherein the BMU and BHMU continually monitor a battery voltage, a current, and a temperature of the battery module.

8. The portable ground power source of claim 6 wherein the battery modules comprise:
a NATO 3-pin connector;
a Ni tab serving as interconnect between cells; and
a high power Li-ion cell.
